(19) United States
(12) Patent Application Publication
(10) Pub. No.: US 2022/0024715 A1
(43) Pub. Date: Jan. 27, 2022

(54) BEAM CLIMBER BRAKE CONDITION-BASED MONITORING SYSTEM

(71) Applicant: Otis Elevator Company, Farmington, CT (US)

(72) Inventor: Randy Roberts, Hebron, CT (US)

(21) Appl. No.: 16/939,640

(22) Filed: Jul. 27, 2020

(51) Int. Cl. B66B 1/32; B66B 5/00

(52) U.S. Cl. CPC B66B 1/32; B66B 5/0025; B66B 5/0031

(57) ABSTRACT

A system for detecting a dragging brake of an elevator system including: an elevator car configured to travel through an elevator shaft; a first guide beam extending vertically through the elevator shaft, the first guide beam including a first surface and a second surface opposite the first surface; a beam climber system configured to move the elevator car through the elevator shaft, the beam climber system including: a first wheel in contact with the first surface; and a first electric motor configured to rotate the first wheel; at least one brake configured to slow the elevator car to a stop; and a brake condition based monitoring system configured to determine a brake health of the at least one brake.

### BACKGROUND

The subject matter disclosed herein relates generally to the field of elevator systems, and specifically to a method and apparatus for detecting brake health on brakes of a propulsion systems for an elevator car.

Elevator cars are conventionally operated by ropes and counter weights, which typically only allow one elevator car in an elevator shaft at a single time.

### BRIEF SUMMARY

According to an embodiment, a system for detecting a dragging brake of an elevator system is provided. The system including: an elevator car configured to travel through an elevator shaft; a first guide beam extending vertically through the elevator shaft, the first guide beam including a first surface and a second surface opposite the first surface; a beam climber system configured to move the elevator car through the elevator shaft, the beam climber system including: a first wheel in contact with the first surface; and a first electric motor configured to rotate the first wheel; at least one brake configured to slow the elevator car to a stop; and a brake condition based monitoring system configured to determine a brake health of the at least one brake.

In addition to one or more of the features described herein, or as an alternative, further embodiments may include an accelerometer configured to detect an acceleration of the elevator car or the beam climber system, wherein the brake condition based monitoring system is configured to move the elevator car up or down at a selected speed and then the at least one brake is applied, and wherein the brake condition based monitoring system compares an actual deceleration rate of the elevator car to a known normal deceleration rate to determine the brake health.

In addition to one or more of the features described herein, or as an alternative, further embodiments may include that the at least one brake further includes: a first motor brake mechanically connected to the first electric motor.

In addition to one or more of the features described herein, or as an alternative, further embodiments may include a first guide rail extending vertically through the elevator shaft, wherein the at least one brake further includes a first guide rail brake operably connected to the first guide rail.

In addition to one or more of the features described herein, or as an alternative, further embodiments may include a first guide rail extending vertically through the elevator shaft, wherein the at least one brake further includes: a first guide rail brake operably connected to the first guide rail; and a first motor brake mechanically connected to the first electric motor.

In addition to one or more of the features described herein, or as an alternative, further embodiments may include a second wheel in contact with the second surface; a second guide beam extending vertically through the elevator shaft, the second guide beam including a first surface of the second guide beam and a second surface of the second guide beam opposite the first surface of the second guide beam, wherein the beam climber system further includes: a third wheel in contact with the first surface of the second guide beam; and a second electric motor configured to rotate the third wheel, and wherein the at least one brake further includes: a second motor brake mechanically connected to the second electric motor.

In addition to one or more of the features described herein, or as an alternative, further embodiments may include a second wheel in contact with the second surface; and a second guide beam extending vertically through the elevator shaft, the second guide beam including a first surface of the second guide beam and a second surface of the second guide beam opposite the first surface of the second guide beam, wherein the beam climber system further includes: a third wheel in contact with the first surface of the second guide beam; and a second electric motor configured to rotate the third wheel, and wherein the at least one brake further includes: a second motor brake mechanically connected to the second electric motor

In addition to one or more of the features described herein, or as an alternative, further embodiments may include a second guide rail extending vertically through the elevator shaft, wherein the at least one brake further includes a second guide rail brake operably connected to the second guide rail.

In addition to one or more of the features described herein, or as an alternative, further embodiments may include a second guide rail extending vertically through the elevator shaft, wherein the at least one brake further includes a second guide rail brake operably connected to the second guide rail.

In addition to one or more of the features described herein, or as an alternative, further embodiments may include a second guide rail extending vertically through the elevator shaft, wherein the at least one brake further includes a second guide rail brake operably connected to the second guide rail.

In addition to one or more of the features described herein, or as an alternative, further embodiments may include a second guide rail extending vertically through the elevator shaft, wherein the at least one brake further includes a second guide rail brake operably connected to the second guide rail.

In addition to one or more of the features described herein, or as an alternative, further embodiments may include a human sensing device configured to determine whether the elevator car is empty of humans prior to determining the brake health of the at least one brake.

In addition to one or more of the features described herein, or as an alternative, further embodiments may include that the first guide beam is an I-beam.

According to another embodiment, a method of detecting a dragging brake of an elevator system is provided. The method including: rotating, using a first electric motor of a beam climber system, a first wheel, the first wheel being in contact with a first surface of a first guide beam that extends vertically through an elevator shaft; moving, using the beam climber system, an elevator car through the elevator shaft when the first wheel of the beam climber system rotates along the first surface of the first guide beam; activating, using a brake condition based monitoring system, at least one brake to slow the elevator car; and determining, using the brake condition based monitoring system, a brake health of the at least one brake.

In addition to one or more of the features described herein, or as an alternative, further embodiments may include: detecting, using an accelerometer, an acceleration of the elevator car or the beam climber system, wherein the brake condition based monitoring system compares an actual deceleration rate of the elevator car to a known normal deceleration rate to determine the brake health.

In addition to one or more of the features described herein, or as an alternative, further embodiments may include determining, using a human sensing device, whether the elevator car is empty of humans prior to rotating the first wheel.

In addition to one or more of the features described herein, or as an alternative, further embodiments may include that the at least one brake further includes: a first motor brake mechanically connected to the first electric motor.

In addition to one or more of the features described herein, or as an alternative, further embodiments may include that the elevator system further includes: a first guide rail extending vertically through the elevator shaft, and wherein the at least one brake further includes a first guide rail brake operably connected to the first guide rail.

In addition to one or more of the features described herein, or as an alternative, further embodiments may include the elevator system further includes: a first guide rail extending vertically through the elevator shaft, wherein the at least one brake further includes: a first guide rail brake operably connected to the first guide rail; and a first motor brake mechanically connected to the first electric motor.

In addition to one or more of the features described herein, or as an alternative, further embodiments may include that the elevator system further includes: a second wheel in contact with the second surface; and a second guide beam extending vertically through the elevator shaft, the second guide beam including a first surface of the second guide beam and a second surface of the second guide beam opposite the first surface of the second guide beam, wherein the beam climber system further includes: a third wheel in contact with the first surface of the second guide beam; and a second electric motor configured to rotate the third wheel, and wherein the at least one brake further includes: a second motor brake mechanically connected to the second electric motor.

Technical effects of embodiments of the present disclosure include testing brakes of a beam climber system by applying the brakes one at a time or in different combinations and monitoring sensors during the associated system response to the brake testing.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system with a beam climber system, in accordance with an embodiment of the disclosure;

FIG. 2 illustrates a schematic view of a brake condition based monitoring system, in accordance with an embodiment of the disclosure; and

FIG. 3 is a flow chart of method of detecting a dragging brake of an elevator system, in accordance with an embodiment of the disclosure.

### DETAILED DESCRIPTION

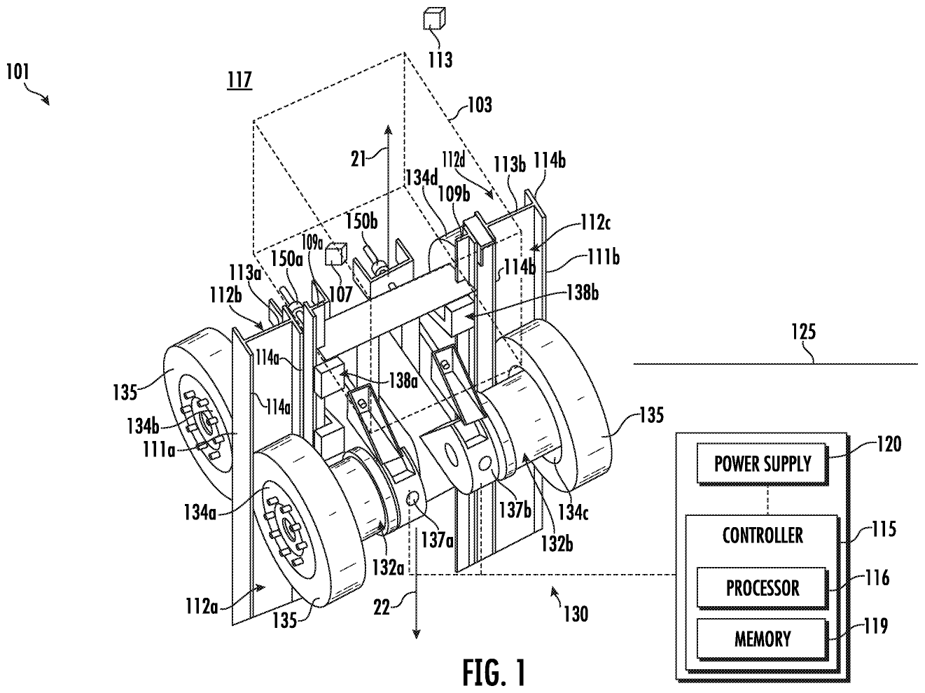

FIG. 1 is a perspective view of an elevator system 101 including an elevator car 103, a beam climber system 130, a controller 115, and a power source 120. Although illustrated in FIG. 1 as separate from the beam climber system 130, the embodiments described herein may be applicable to a controller 115 included in the beam climber system 130 (i.e., moving through an elevator shaft 117 with the beam climber system 130) and may also be applicable to a controller located off of the beam climber system 130 (i.e., remotely connected to the beam climber system 130 and stationary relative to the beam climber system 130). Although illustrated in FIG. 1 as separate from the beam climber system 130, the embodiments described herein may be applicable to a power source 120 included in the beam climber system 130 (i.e., moving through the elevator shaft 117 with the beam climber system 130) and may also be applicable to a power source located off of the beam climber system 130 (i.e., remotely connected to the beam climber system 130 and stationary relative to the beam climber system 130).

The beam climber system 130 is configured to move the elevator car 103 within the elevator shaft 117 and along guide rails 109a, 109b that extend vertically through the elevator shaft 117. In an embodiment, the guide rails 109a, 109b are T-beams. The beam climber system 130 includes one or more electric motors 132a, 132b. The electric motors 132a, 132b are configured to move the beam climber system 130 within the elevator shaft 117 by rotating one or more wheels 134a, 134b that are pressed against a guide beam 111a, 111b. In an embodiment, the guide beams 111a, 111b are I-beams. It is understood that while an I-beam is illustrated any beam or similar structure may be utilized with the embodiment described herein. Friction between the wheels 134a, 134b, 134c, 134d driven by the electric motors 132a, 132b allows the wheels 134a, 134b, 134c, 134d to climb up 21 and down 22 the guide beams 111a, 111b. The guide beam extends vertically through the elevator shaft 117. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to beam climber systems 130 having one or more electric motors. For example, the beam climber system 130 may have one electric motor for each of the four wheels 134a, 134b, 134c, 134d. The electrical motors 132a, 132b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 103).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a. The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method. The first compression mechanism 150a may be adjustable in real-time during operation of the elevator system 101 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the elevator shaft 117, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 103.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b. The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 101 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the elevator shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132b is configured to rotate the third wheel 134c to climb up 21 or down 22 the second guide beam 111b. The second electric motor 132b may also include a second motor brake 137b to slow and stop rotation of the second motor 132b. The second motor brake 137b may be mechanically connected to the second motor 132b. The second motor brake 137b may be a clutch system, a disc brake system, a drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109 proximate the elevator car 103.

The elevator system 101 may also include a position reference system 113. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the elevator system (e.g., the elevator car 103 or the beam climber system 130), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 103 and the beam climber system 130. For example, the controller 115 may provide drive signals to the beam climber system 130 to control the acceleration, deceleration, leveling, stopping, etc. of the elevator car 103.

The controller 115 may also be configured to receive position signals from the position reference system 113 or any other desired position reference device.

When moving up 21 or down 22 within the elevator shaft 117 along the guide rails 109a, 109b, the elevator car 103 may stop at one or more landings 125 as controlled by the controller 115. In one embodiment, the controller 115 may be located remotely or in the cloud. In another embodiment, the controller 115 may be located on the beam climber system 130

The power supply 120 for the elevator system 101 may be any power source, including a power grid and/or battery power which, in combination with other components, is supplied to the beam climber system 130. In one embodiment, power source 120 may be located on the beam climber system 130. In an embodiment, the power supply 120 is a battery that is included in the beam climber system 130.

The elevator system 101 may also include an accelerometer 107 attached to the elevator car 103 or the beam climber system 130. The accelerometer 107 is configured to detect an acceleration and/or a speed of the elevator car 103 and the beam climber system 130.

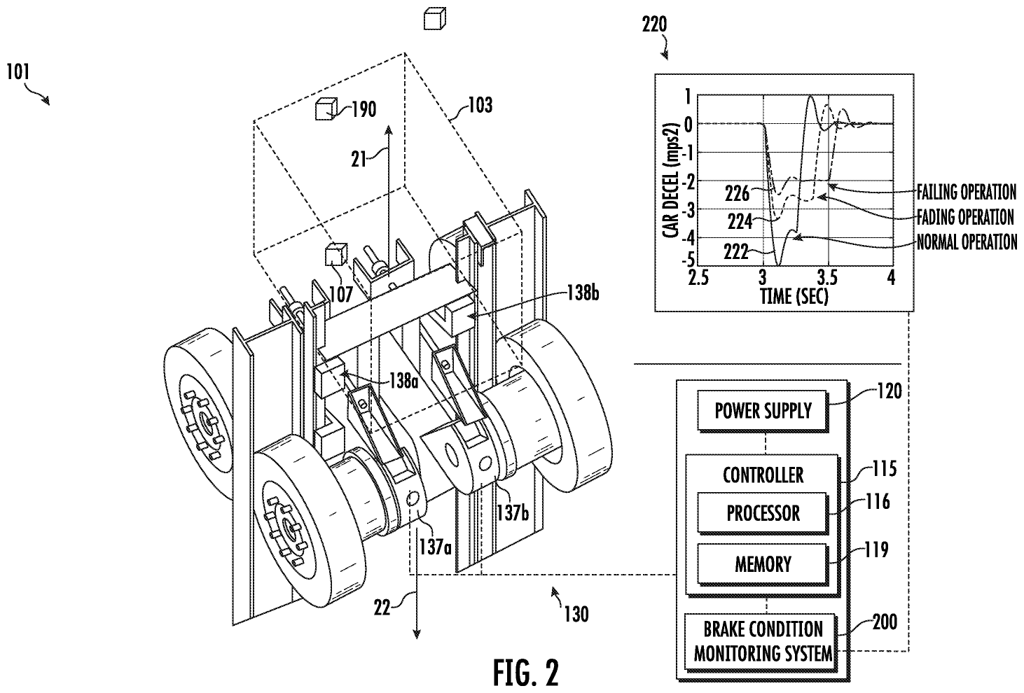

Referring now to FIG. 2, with continued reference to FIG. 1, a brake condition based monitoring system 200 is illustrated, in accordance with an embodiment of the present disclosure. It should be appreciated that, although particular systems are separately defined in the schematic block diagrams, each or any of the systems may be otherwise combined or separated via hardware and/or software. In one embodiment, the brake condition based monitoring system 200 may be a separate hardware module in electronic communication with the controller 115. The separate hardware module may be local or remote (e.g., software as a service). In another embodiment, the brake condition based monitoring system 200 may be software installed directly on the memory 119 of the controller 115 and the software may consist of operations to be performed by the processor 116. In one embodiment, the brake condition based monitoring system 200 may communicate with the cloud or a service worker's diagnostic tool and may optionally also be in communication with the controller 115.

The elevator system 101 includes at least one brake 137a, 137b, 138a, 138b configured to slow the elevator car 103 to a stop. The brake condition based monitoring system 200 is configured to assess the health and braking force or torque of brakes 137a, 137b, 138a, 138b of the beam climber system 130. More specifically, the brake condition based monitoring system 200 is configured to determine a brake health of the brakes 137a, 137b, 138a, 138b of the beam climber system 130. The brakes 137a, 137b, 138a, 138b of the beam climber system 130 includes the first motor brake 137a, the second motor brake 137b, the first guide rail brake 138a, and the second guide rail brake 138b. The brake condition based monitoring system 200 is configured to control, through the controller 115, the first motor brake 137a, the second motor brake 137b, the first guide rail brake 138a, and/or the second guide rail brake 138b. In other words, the brake condition based monitoring system 200 is configured to control, through the controller 115, at least one of the first motor brake 137a, the second motor brake 137b, the first guide rail brake 138a, or the second guide rail brake 138b.

The brake condition based monitoring system 200 is configured to place the elevator system 101 in a specialized control mode where motion of the elevator car 103 and application of the brakes 137a, 137b, 138a, 138b would be controlled, the vehicle acceleration would be monitored, and data processing would be used to assess and predict a brake health of each individual brake.

Additional sensors, such as gap and tilt sensors may be utilized to supplement the acceleration readings in order to determine a brake health. A healthy brake 137a, 137b, 138a, 138b would be one that delivers a braking force within selected tolerance band of torque (e.g., 1000 Nm-1500 Nm). For a given empty elevator car weight and the selection of brakes activated once could infer the contribution of each brake 137a, 137b, 138a, 138b to the brake torque value. If the brake torque is inside the selected tolerance band of torque that defines “normal” then the brake 137a, 137b, 138a, 138b may be determined to be healthy. If the brake torque is out of normal spec or the selected tolerance band of torque then guidance may be provided to a brake health monitoring output (i.e., okay, flag as maintenance check at next visit, or shutdown system and pull car from service).

The specialized control mode may include a series of low speed braking responses that exercise a combination of sequenced brakes being dropped. The brakes 137a, 137b, 138a, 138b may be tested one at a time or in various combinations with each other to identify a brake with poor health.

In one example, the elevator car 103 may be moved up 21 or down 22 at a selected speed and then the first motor brake 137a may be applied fully, partially, are at a selected percentage of being fully applied (e.g., 50%) . The actual deceleration rate of the elevator car 103 may then be compared to a known normal deceleration rate to determine a brake health of the first motor brake 137a.

In another example, the elevator car 103 may be moved up 21 or down 22 at a selected speed and then the second motor brake 137b may be applied. The actual deceleration rate of the elevator car 103 may then be compared to a known normal deceleration rate to determine a brake health of the second motor brake 137b.

In another example, the elevator car 103 may be moved up 21 or down 22 at a selected speed and then the first guide rail brake 138a may be applied. The actual deceleration rate of the elevator car 103 may then be compared to a known normal deceleration rate to determine a brake health of the first guide rail brake 138a. The actual deceleration rate may be an average value over a transient to avoid any erratic vibrations during braking transient.

In another example, the elevator car 103 may be moved up 21 or down 22 at a selected speed and then the second guide rail brake 138b may be applied. The actual deceleration rate of the elevator car 103 may then be compared to a known normal deceleration rate to determine a brake health of the second guide rail brake 138b.

In another example, the elevator car 103 may be moved up 21 or down 22 at a selected speed and then the first motor brake 137a, the second motor brake 137b, the first guide rail brake 138a, and/or the second guide rail brake 138b may be applied. In other words, the elevator car 103 may be moved up 21 or down 22 at a selected speed and then at least one of the first motor brake 137a, the second motor brake 137b, the first guide rail brake 138a, or the second guide rail brake 138b may be applied. The actual deceleration rate of the elevator car 103 may then be compared to a known normal deceleration rate to determine a brake health of the first motor brake 137a, the second motor brake 137b, the first guide rail brake 138a, and/or the second guide rail brake 138b. The actual deceleration rate of the elevator car 103 may then be compared to a known normal deceleration rate to determine a brake health of the first motor brake 137a, the second motor brake 137b, the first guide rail brake 138a, and/or the second guide rail brake 138b.

Different combinations of brakes 137a, 137b, 138a, 138b may be applied and compared to narrow down which brake may be functioning poorly or has poor health.

The different combinations of brakes 137a, 137b, 138a, 138b may be tested using a test matrix that may look like the following: test1—all on, test2—left-front, right-front on, test3—left-back; right back on, test4: left front, right back on, tests: left back, right front on when you have two left and two right brakes. This matrix of options would allow you to isolate which brakes 137a, 137b, 138a, 138b were out of spec.

The actual deceleration of the elevator car 103 may be measured by the accelerometer 107. The actual deceleration may be compared to a known normal deceleration rate 222, a known fading deceleration rate 224, and a known failing deceleration rate 226, as shown in the known deceleration rate versus time chart 220.

If the actual deceleration of the elevator car 103 is closest to the known normal deceleration rate 222, it would mean that the brake 137a, 137b, 138a, 138b is operating normally. If the actual deceleration of the elevator car 103 is closest to the known fading operation rate 224, it would mean that the brake 137a, 137b, 138a, 138b is fading. If the actual deceleration of the elevator car 103 is closest to the known failing deceleration rate 226, it would mean that the brake 137a, 137b, 138a, 138b is failing. For example, all the test data may be used to back estimate what the various brake torques must be to result in the observed results in all the combined tests.

Prior to entering the specialized control mode, the elevator system 101 may be required to determine whether the elevator car 103 is empty of humans. In an embodiment, the brake condition based monitoring system 200 may be prevented from entering the specialized control mode if humans are detected in the elevator car. In other words, in an embodiment, the elevator car 103 must be free of humans prior to the brake condition based monitoring system 200 entering the specialized control mode. It is understood that the embodiments disclosed herein are not limited to the elevator car 103 being free of humans during the specialized control mode. This is dependent of the intensity of braking being utilized for the specialized control mode. If the braking is intense, the elevator car 103 would have to be free of humans but if the braking is at or below normal braking intensity then humans may be located in the elevator car 103. Normal braking intensity would be the braking intensity utilized when normal carry humans during normal operations.

The elevator system 101 may include a human sensing device 190. The human sensing device 190 may be composed of at least one of a camera, a depth sensing device, a RADAR device, a thermal detection device, a floor pressure sensor, a microphone, or any similar human detection device known to one of skill in the art. The human sensing device 190 may also comprise any other device capable of sensing the presence of humans, as known to one of skill in the art. The human sensing device 190 may utilize the camera to detect a human and/or an object within the elevator car 103. The camera may be configured to capture an image or video within the elevator car 103. The depth sensing device may be a 2-D, 3-D or other depth/distance detecting camera that utilizes detected distance to an object and/or a human to detect a human and/or an object within the elevator car 103. The depth sensing device generates depth maps for analysis. The RADAR device may utilize radio waves to detect a human and/or an object within the elevator car 103. The RADAR device generates RADAR signals for analysis. The thermal detection device may be an infrared or other heat sensing camera that utilizes detected temperature to detect a human and/or an object within the elevator car 103. The thermal detection device generates thermal images for analysis. The floor pressure sensor may be one or more pressure sensors located in the floor of an elevator car 103 that utilizes pressure data on the floor to detect a human and/or an object within the elevator car 103. The floor pressure sensor generates a pressure map for analysis. The human sensing system 190 may additionally include a microphone configured to capture sound data within the elevator car 103. As may be appreciated by one of skill in the art, in addition to the stated methods, additional methods may exist to detect humans and objects, thus one or any combination of these methods may be used to determine the presence of humans or objects in an elevator car 103.

The brake tests would be done at a low speed condition to reduce any risk to unintended passengers. The human sensing system 190 may have a load weighing sensing system that could be used to identify passengers. Detections from the load weighing system may be used to update and refine the estimate of the empty elevator car 103 weight which could be used to accommodate that load in the brake acceleration post processing to identify individual brake torque values in the brake condition based monitoring system 200.

The human sensing device 190 may utilize a cognitive service that is configured to detect an individual and/or an object within the elevator car 103 through image recognition, video analytics, neural networks, machine learning, deep learning, artificial intelligence, speech recognition, computer vision, video indexer or any other known method to one of skill in the art.

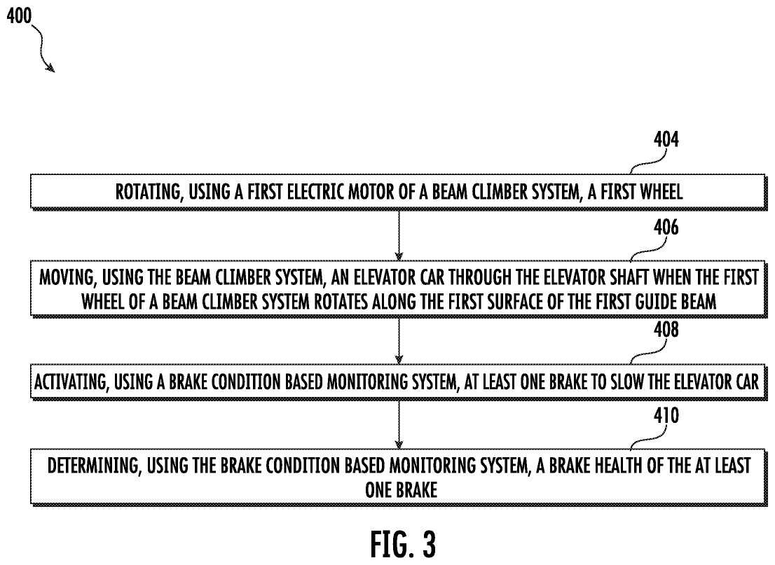

Referring now to FIG. 3, with continued reference to FIGS. 1-2, a flow chart of method 400 of detecting a dragging brake operating an elevator systems 101 is illustrated, in accordance with an embodiment of the disclosure.

At block 404, a first electric motor 132a of a beam climber system 130 rotates a first wheel 134a. The first wheel 134a being in contact with a first surface 112a of a first guide beam 111a that extends vertically through an elevator shaft 117.

At block 406, the beam climber system 130 moves an elevator car 103 through the elevator shaft when the first wheel 134a of the beam climber system 130 rotates along the first surface 112a of the first guide beam 111a.

At block 408, a brake condition based monitoring system 200 activates at least one brake to slow the elevator car 103. The at least one brake includes the first motor brake 137a, the second motor brake 137b, the first guide rail brake 138a, and/or the second guide rail brake 138b. In other words, the at least one brake includes at least one of the first motor brake 137a, the second motor brake 137b, the first guide rail brake 138a, or the second guide rail brake 138b.

At block 410, the brake condition based monitoring system 200 determines a brake health of the at least one brake.

The method 400 may further comprise that an accelerometer 107 detects an acceleration of the elevator car 103 or the beam climber system 130. The brake condition based monitoring system 200 is configured to move the elevator car 103 up 21 or down 22 at a selected speed and then the at least one brake is applied. The brake condition based monitoring system 200 compares an actual deceleration rate of the elevator car 103 to a known normal deceleration rate to determine the brake health.

The method 400 may further comprise that a human sensing device 190 determines whether the elevator car 103 is empty of humans prior to rotating the first wheel 134a in block 404.

Alternatively, the brake condition based monitoring system 200 may test the brakes 137a, 137b, 138a, 138b by first confirming that the elevator car 103 is out of service and then the brake tests can be conducted. The brake tests may include running a matrix of tests with test factors including but not limited to: direction (up/down) of the elevator car 103, speed (e.g., probably a fixed single low speed) of elevator car 103, and what brakes or combination of brakes are being dropped. After performing the matrix of test, the brake condition based monitoring system 200 may then extract decal valued from all of the test conditions and estimate brake torques from by least squares estimate of the best fit to all the test data. Lastly, the brake condition based monitoring system 200 is configured to identify any accommodations or recommendations indicated (e.g., okay, left back brake is fading, log a service request for future maintenance action, bring elevator car out of service due to brake failed health check).

Additionally, the electric motors 132a, 132b may be left on or shut down during the testing of the brakes 137a, 137b, 138a, 138b. The electric motors 132a, 132b may be left on to control the vehicle speed during the brake stops. Leaving the electric motors 132a, 132b on may help provide torque to maintain the vertical position of the elevator car 103 and the beam climber system 130 in the elevator shaft 117.

While the above description has described the flow process of FIG. 3 in a particular order, it should be appreciated that unless otherwise specifically required in the attached claims that the ordering of the steps may be varied.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system for detecting a dragging brake of an elevator system, the system comprising:
an elevator car configured to travel through an elevator shaft;
a first guide beam extending vertically through the elevator shaft, the first guide beam comprising a first surface and a second surface opposite the first surface;
a beam climber system configured to move the elevator car through the elevator shaft, the beam climber system comprising:
a first wheel in contact with the first surface; and
a first electric motor configured to rotate the first wheel;
at least one brake configured to slow the elevator car to a stop; and
a brake condition based monitoring system configured to determine a brake health of the at least one brake.

2. The system of claim 1, further comprising:
an accelerometer configured to detect an acceleration of the elevator car or the beam climber system,
wherein the brake condition based monitoring system is configured to move the elevator car up or down at a selected speed and then the at least one brake is applied, and
wherein the brake condition based monitoring system compares an actual deceleration rate of the elevator car to a known normal deceleration rate to determine the brake health.

3. The system of claim 1, wherein the at least one brake further comprises:
a first motor brake mechanically connected to the first electric motor.

4. The system of claim 3, further comprising:
a first guide rail extending vertically through the elevator shaft,
wherein the at least one brake further comprises a first guide rail brake operably connected to the first guide rail.

5. The system of claim 1, further comprising:
a first guide rail extending vertically through the elevator shaft,
wherein the at least one brake further comprises:
a first guide rail brake operably connected to the first guide rail; and
a first motor brake mechanically connected to the first electric motor.

6. The system of claim 3, further comprising:
a second wheel in contact with the second surface;
a second guide beam extending vertically through the elevator shaft, the second guide beam comprising a first surface of the second guide beam and a second surface of the second guide beam opposite the first surface of the second guide beam,
wherein the beam climber system further comprises:
a third wheel in contact with the first surface of the second guide beam; and
a second electric motor configured to rotate the third wheel, and
wherein the at least one brake further comprises:
a second motor brake mechanically connected to the second electric motor.

7. The system of claim 5, further comprising:
a second wheel in contact with the second surface; and
a second guide beam extending vertically through the elevator shaft, the second guide beam comprising a first surface of the second guide beam and a second surface of the second guide beam opposite the first surface of the second guide beam,
wherein the beam climber system further comprises:
a third wheel in contact with the first surface of the second guide beam; and
a second electric motor configured to rotate the third wheel, and
wherein the at least one brake further comprises:
a second motor brake mechanically connected to the second electric motor

8. The system of claim 4, further comprising:
a second guide rail extending vertically through the elevator shaft, wherein the at least one brake further comprises a second guide rail brake operably connected to the second guide rail.

9. The system of claim 5, further comprising:
a second guide rail extending vertically through the elevator shaft, wherein the at least one brake further comprises a second guide rail brake operably connected to the second guide rail.

10. The system of claim 6, further comprising:
a second guide rail extending vertically through the elevator shaft, wherein the at least one brake further comprises a second guide rail brake operably connected to the second guide rail.

11. The system of claim 7, further comprising:
a second guide rail extending vertically through the elevator shaft, wherein the at least one brake further comprises a second guide rail brake operably connected to the second guide rail.

12. The system of claim 1, further comprising:
a human sensing device configured to determine whether the elevator car is empty of humans prior to determining the brake health of the at least one brake.

13. The system of claim 1, wherein the first guide beam is an I-beam.

14. A method of detecting a dragging brake of an elevator system, the method comprising:
rotating, using a first electric motor of a beam climber system, a first wheel, the first wheel being in contact with a first surface of a first guide beam that extends vertically through an elevator shaft;
moving, using the beam climber system, an elevator car through the elevator shaft when the first wheel of the beam climber system rotates along the first surface of the first guide beam;
activating, using a brake condition based monitoring system, at least one brake to slow the elevator car; and
determining, using the brake condition based monitoring system, a brake health of the at least one brake.

15. The method of claim 14, further comprising:
detecting, using an accelerometer, an acceleration of the elevator car or the beam climber system,
wherein the brake condition based monitoring system compares an actual deceleration rate of the elevator car to a known normal deceleration rate to determine the brake health.

16. The method of claim 14, further comprising:
determining, using a human sensing device, whether the elevator car is empty of humans prior to rotating the first wheel.

17. The method of claim 14, wherein the at least one brake further comprises:
a first motor brake mechanically connected to the first electric motor.

18. The method of claim 14, wherein the elevator system further comprises:
a first guide rail extending vertically through the elevator shaft, and
wherein the at least one brake further comprises a first guide rail brake operably connected to the first guide rail.

19. The method of claim 14, wherein the elevator system further comprises:
a first guide rail extending vertically through the elevator shaft,
wherein the at least one brake further comprises:
a first guide rail brake operably connected to the first guide rail; and
a first motor brake mechanically connected to the first electric motor.

20. The method of claim 17, wherein the elevator system further comprises:
a second wheel in contact with the second surface; and
a second guide beam extending vertically through the elevator shaft, the second guide beam comprising a first surface of the second guide beam and a second surface of the second guide beam opposite the first surface of the second guide beam,
wherein the beam climber system further comprises:
a third wheel in contact with the first surface of the second guide beam; and
a second electric motor configured to rotate the third wheel, and wherein the at least one brake further comprises:
a second motor brake mechanically connected to the second electric motor.
